(19) United States
(12) Patent Application Publication
(10) Pub. No.: US 2004/0268367 A1
(43) Pub. Date: Dec. 30, 2004

(54) Method for managing a callback object in an event-based environment using weak references

(76) Inventors: Bryan Y. Roe, Camas, WA (US); Ylian Saint-Hilaire, Hillsboro, OR (US); Nelson F. Kidd, Camas, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/611,243

(22) Filed: Jun. 30, 2003

(51) Int. Cl. G06F 9/46

(52) U.S. Cl. 719/318

(57) ABSTRACT

A method, machine readable medium, and system is disclosed. In one embodiment the method comprises intercepting the communications between a callback object and an event source, emulating at least a portion of the functionality of the callback object to the event source, emulating at least a portion of the functionality of the event source to the callback object, and replacing any strong reference to the callback object with a weak reference.

### BACKGROUND

In a development environment that utilizes a garbage collector, such as Microsoft's .NET or the Java environment, object management can become tedious when events are used. A garbage collector usually functions by monitoring all of the objects in memory and discarding them when they are no longer useful. An object is determined to be no longer needed when no other objects in memory are referencing that object. Whenever an object holds a reference to another object, which prevents that object from being collected by the garbage collector, it is called a strong reference. A weak reference is a special type of reference to another object that is ignored by the garbage collector.

An event is a message sent by an event publisher object (the event source) to signal the occurrence of an action. An object that wants to subscribe to the event (a callback object) will send the event source a callback handler that is actually a pointer to a method in the callback object. This callback handler is called a callback delegate.

Memory management through garbage collection becomes complex in an environment that utilizes events. Garbage collection is made more difficult because delegates hold strong references to the callback objects to which they point. Thus, a callback object will never get collected by the garbage collector until it unsubscribes to all events. This can get complicated when the developer subscribes a callback object to any system event because the system's runtime engine will hold a strong reference to the callback object. As a result, the developer's callback object may never get collected by the garbage collector because the event can be a necessary operation and cannot be unsubscribed. Although an event should not necessarily dictate the lifetime of a callback object, unfortunately this is what happens in many cases.

Additionally, handling events in a managed environment is quite complicated because the default handling mechanism is not inherently thread-safe. The event publisher could be operating in multiple threads, which causes problems. On the callback object side, one thread could subscribe to an event and then operate while another thread unsubscribes to the same event moments later. The first thread's functionality and integrity is then compromised because it operates under a mistaken assumption. This issue leads to abnormalities in the callback object's functionality. On the other hand, the publisher could be operating with multiple threads and pose a similar problem. One publisher thread could check to see if any callback delegates are currently subscribed to a given source event originating from the publisher and report back the results. Then, before a second thread that handles event-firing has a chance to respond, a callback object could subscribe or unsubscribe to the same event, which leads to a problem for the event-firing thread because it is operating on old information.

Event-based management environments are becoming more prolific with the substantial growth of .NET, Java, and other platforms. Thus, there is a need for an effective, thread-safe, and transparent way to manage callback objects in memory and the manner in which they interact with the events to which they subscribe.

### BRIEF DESCRIPTION OF THE DRAWINGS

The present invention is illustrated by way of example and is not limited by the figures of the accompanying drawings, in which like references indicate similar elements, and in which:

FIG. 1 Prior Art demonstrates an embodiment of the relationship between a callback object, and a source event as commonly seen in the known art.

FIG. 2 Prior Art illustrates an embodiment the event subscription process as commonly seen in the known art.

FIG. 3 Prior Art illustrates an embodiment the event firing process as commonly seen in the known art.

FIG. 4 illustrates an embodiment of the overview of the Object/Event Communication Model Using Weak References between a callback object and an event source.

FIG. 5 illustrates an embodiment of the Object/Event Communication Model Using Weak References subscription process.

FIG. 6 illustrates a step-by-step process of how event subscription requests are handled in one embodiment of the Object/Event Communication Model Using Weak References.

FIG. 7A and FIG. 7B illustrate an embodiment of the Object/Event Communication Model Using Weak References event firing process.

FIG. 8 illustrates a step-by-step process of how fired events are handled in one embodiment of the Object/Event Communication Model Using Weak References.

FIG. 9 illustrates a step-by-step process of how event unsubscription requests are handled in one embodiment of the Object/Event Communication Model Using Weak References.

### DETAILED DESCRIPTION

A method for an effective, thread-safe, and transparent way to manage callback objects in an event-based environment is described. In some instances, well-known elements and theories, such as events, JAVA, .NET, etc. have not been discussed in special details in order to avoid obscuring the present invention.

Garbage collection is a valuable process that allows memory to be cleaned up efficiently by monitoring all objects in memory and discarding them when they are no longer of any use. In order for the garbage collector to determine if a given object is ready to be discarded it checks to see if any other objects in memory have strong references pointing to the object. If no strong references exist then the object is discarded. Of course, there are many times where strong references do exist but are no longer needed. It is during these scenarios where an object, which would otherwise be discarded, is needlessly saved. To resolve these scenarios the developer can replace any strong reference that points to the object with a weak reference. A weak reference, while still maintaining a pointer to the object in question, allows the garbage collector to discard the object. Although weak references do exist they are not regularly utilized because development environments such as .NET and Java default to strong references. A developer would incur additional development overhead in order to fully implement weak references. The present invention employs a fully automatic and transparent methodology for implementing weak references with respect to callback objects.

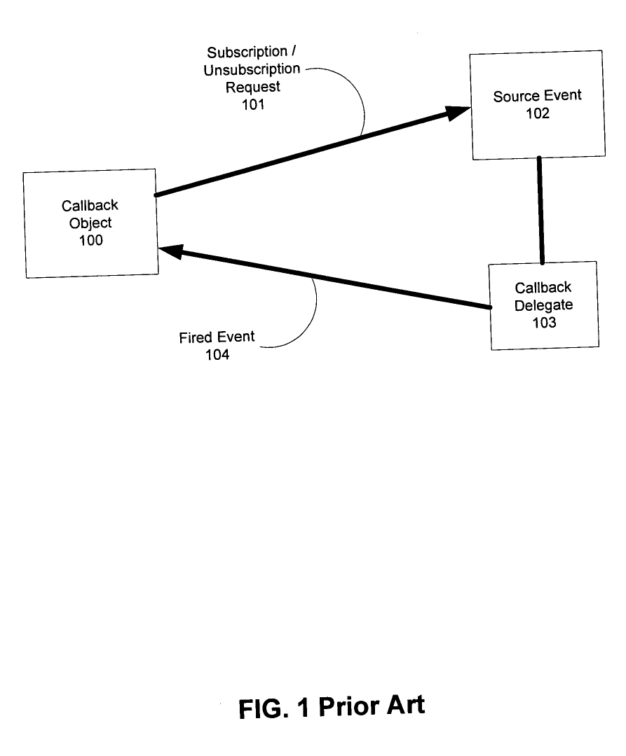

FIG. 1 displays an embodiment of the prior art environment. The Callback Object 100 can send Subscription/Unsubscription Requests 101 to the Event Source 102. In turn, the Event Source 102 can fire an Event 104 to the Callback Object 100 because the Callback Delegate 103 that is registered with the Event Source 102 points to the Callback Object 100.

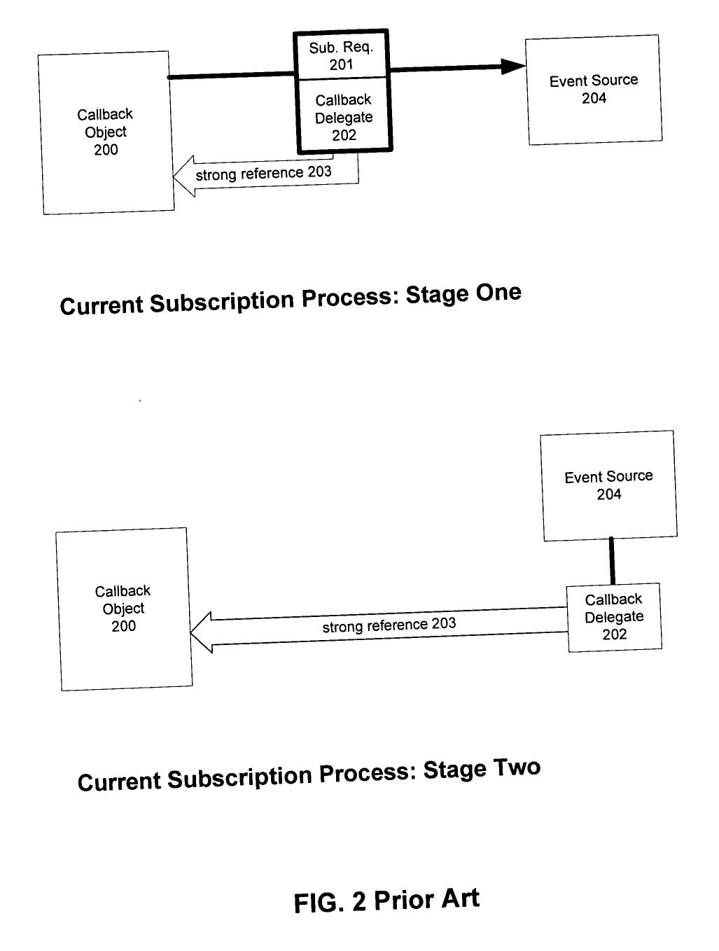

FIG. 2 illustrates an embodiment of the prior art subscription process that takes place, which allows a callback object to register with an event source. Callback Object 200 requires notification whenever Event Source 204 broadcasts its event. Stage one of the subscription process begins when Callback Object 200 sends a Subscription Request 201 to Event Source 204. Subscription Request 201 has attached to it information that includes Callback Delegate 202. Callback Delegate 202 has an event handler (Strong Reference 203) that points back to a given method in Callback Object 200. At Stage two of the subscription process the Event Source 204 takes the Callback Delegate 202 and appends it to its list of callback delegates. Every callback delegate has a reference to its respective callback object (i.e. Callback Delegate 202 has Strong Reference 203 which points to Callback Object 200). At this point Callback Object 200 has successfully subscribed to the event associated with Event Source 204.

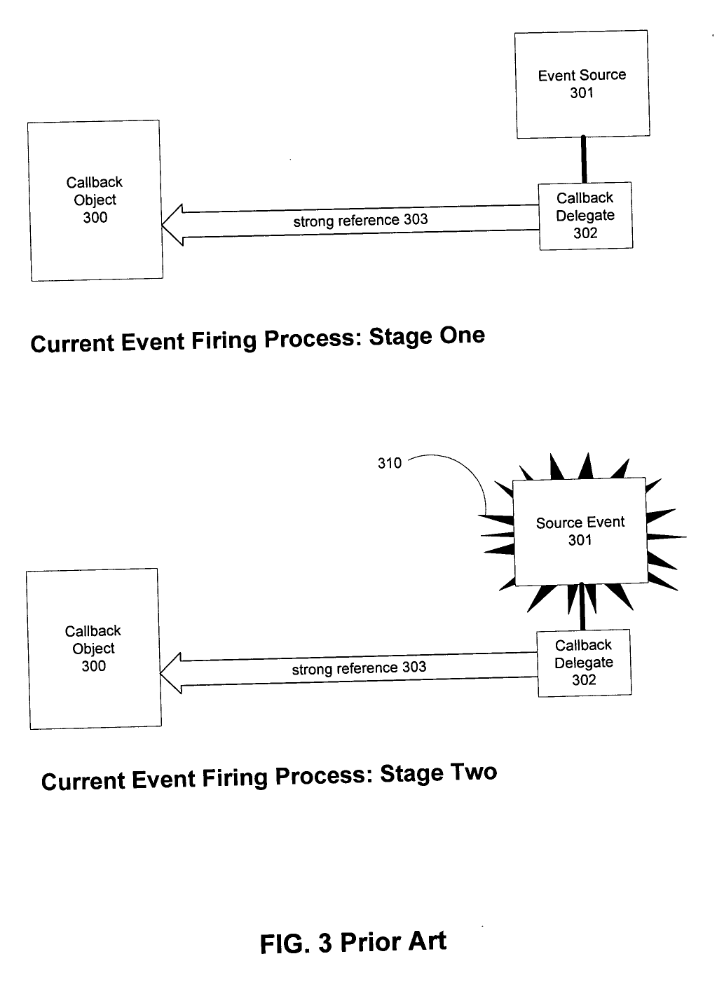

FIG. 3 illustrates an embodiment of the prior art event broadcast process. In Stage one the Callback Object 300 has already completed the registration process with Event Source 301 as described above in reference to FIG. 2. At Stage two of the event broadcast process the Event Source 301 performs a broadcast operation 310. In turn, this procedure executes all callback delegates in the list linked Event Source 301, including Callback Delegate 302. Callback Delegate 302 runs the event handler that links, by way of Strong Reference 303, to a specific method in Callback Object 300. The event broadcast process concludes upon completion of this step.

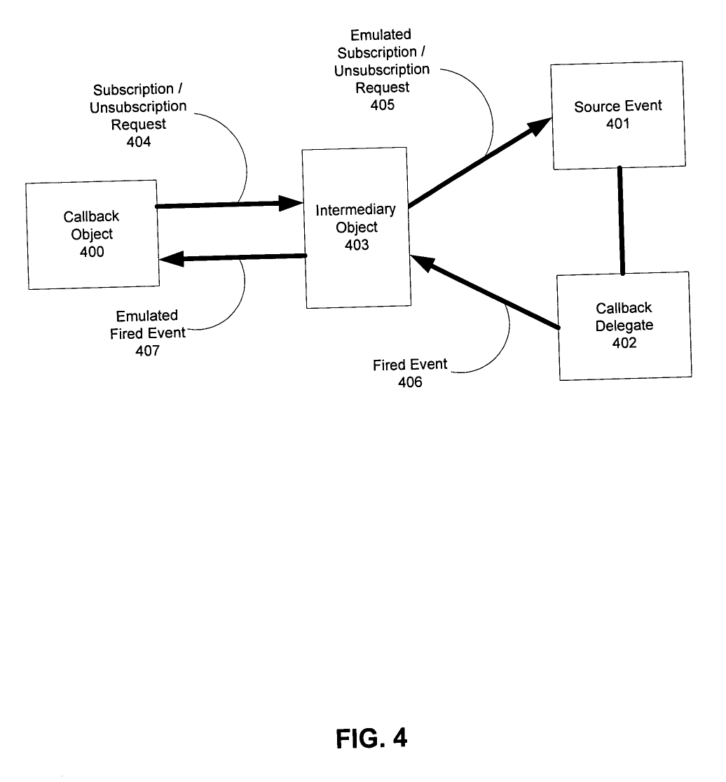

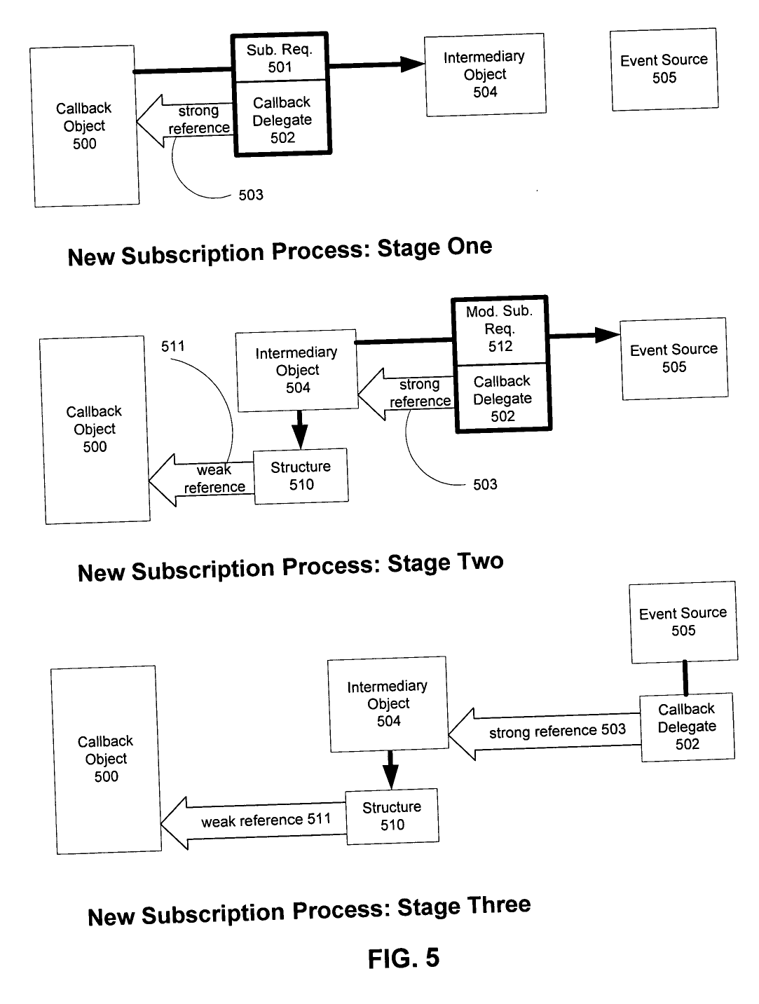

FIG. 4 illustrates an embodiment of the overview of the present invention, an Object/Event Communication Model Using Weak References, between a callback object and an event source. The Callback Object 400 attempts to send a Subscription or Unsubscription Request 404 to the Event Source 401. This request is intercepted by the Intermediary Object 403, which modifies the request and then sends an Emulated Subscription or Unsubscription Request 405 to the Event Source 401. The Event Source 401 handles the request it receives as if it were the original Subscription or Unsubscription Request 404 because the Intermediary Object 403 acts transparently. When an event associated with the Event Source 401 takes place, an Event 406 is fired out to the object pointed to by the Callback Delegate 402. In the current case the Callback Delegate 402 points to the Intermediary Object 403 so the Event 406 is intercepted from traveling directly to the subscribed Callback Object 400. The Intermediary Object 403 processes the Event 406 and then fires the Emulated Event 407 to the Callback Object 400. The details relating to how the Intermediary Object 403 implements weak references and how it modifies the communications between the Callback Object 400 and the Event Source 401 is explained in FIGS. 5-9. In addition to the need to employ a transparent model for implementing weak references it is also desirable to have the communication between events and callback objects to be thread-safe. The Intermediary Object 403 accomplishes this by locking the communication between a given callback object and a given event source to one thread at a time. In other words, the Intermediary Object 403 can function as a locking mechanism for thread communication between a given callback object and a given event source by maintaining serial thread communication between the callback object and event source. This assures only one thread per object can access a callback object or event source at any one time through the Intermediary Object 403.

FIG. 5 illustrates an embodiment of the Object/Event Communication Model Using Weak References subscription process. In stage one of the subscription process a Callback Object 500 attempts to subscribe to an event by sending a Subscription Request 501 to the Event Source 505. The Subscription Request 501 has a Callback Delegate 502 embedded in it that points to the Callback Object 500 using Strong Reference 503. Prior to reaching the Event Source 505, the Subscription Request 501 is intercepted by the Intermediary Object 504.

In stage two of the subscription process the Intermediary Object 504 parses the Subscription Request 501 and extracts all needed information out of it including Strong Reference 503. Intermediary Object 504 then creates a structure and stores all needed information in it about Callback Object 500. Strong Reference 503, which points to Callback Object 500, is modified into Weak Reference 511 and stored in Structure 510. Intermediary Object 504 modifies the Callback Delegate 502 by having the Strong Reference 503 point to the Intermediary Object 504 rather than the Callback Object 500. At this point, the only reference pointing to Callback Object 500 is Weak Reference 511. Subsequently, Intermediary Object 504 sends a Modified Subscription Request 512 to the Event Source 506. The Modified Subscription Request 512 has Callback Delegate 502 embedded in it, which is pointing to the Intermediary Object 504 using Strong Reference 503.

Finally, stage three of the subscription process begins when the Event Source 506 receives the Modified Subscription Request 512. The Event Source 506 appends the Callback Delegate 502 to the end of the list of callback delegates that are to be notified during an event firing. At the completion of the subscription process the Callback Delegate 502, linked to the Event Source 506, is pointing to Intermediary Object 504. Additionally, Structure 510 is linked to Intermediary Object 504 and is pointing to Callback Object 500 using Weak Reference 511.

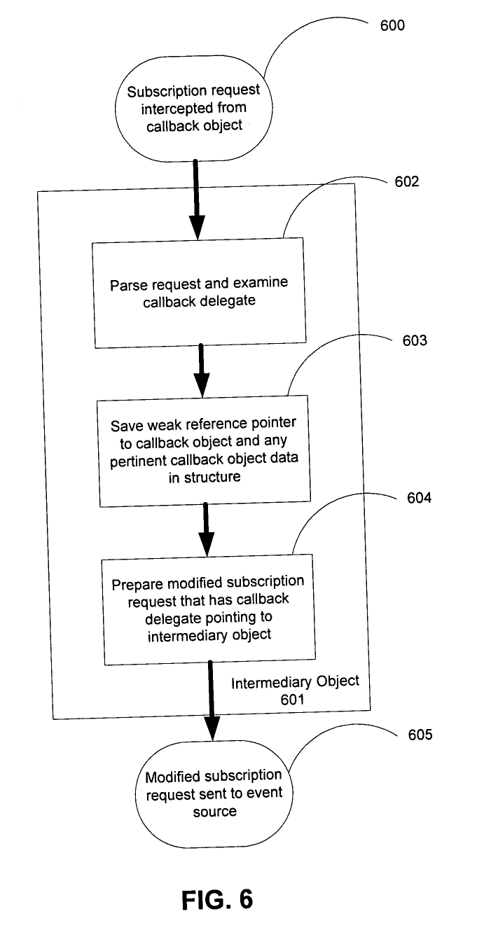

FIG. 6 illustrates a step-by-step process of how event subscription requests are handled in one embodiment of the Object/Event Communication Model Using Weak References. In block 600 a subscription request is intercepted from the callback object by the Intermediary Object 601. The Intermediary Object 601 then parses the subscription request and examines the callback delegate embedded in the request in block 602. Next, in block 603 the Intermediary Object 601 saves the data associated with the callback object and saves a weak reference to the callback object in a structure. In block 603, a modified subscription request is prepared to send to the event source with a callback delegate that points to the Intermediary Object 601. Finally, the modified subscription request is sent to the Event Source in block 605.

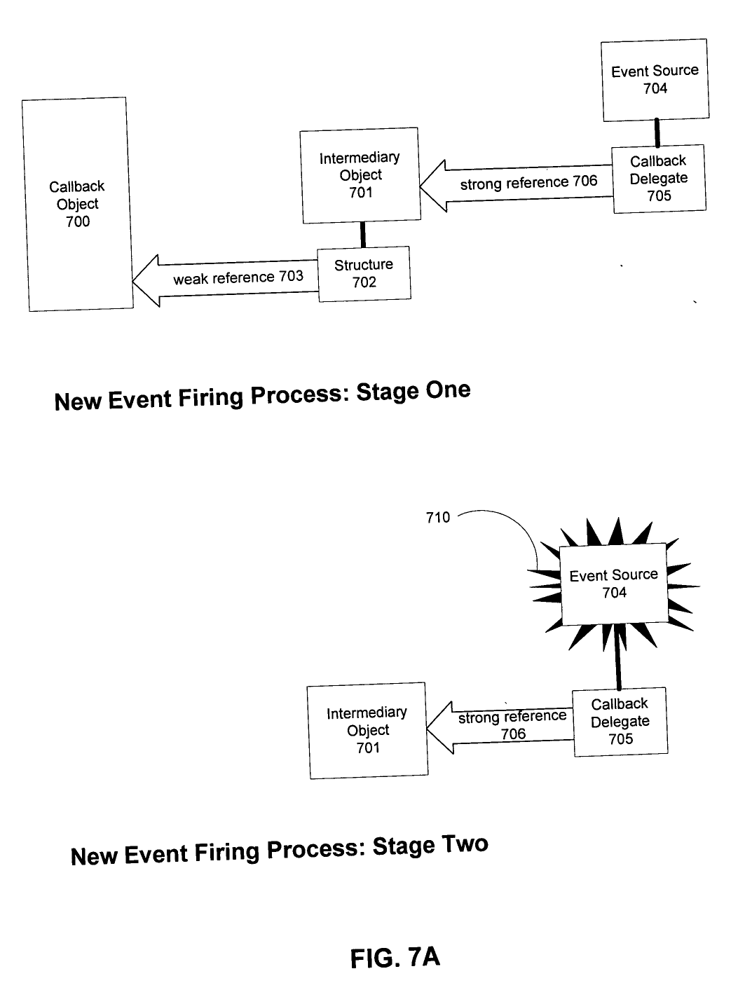

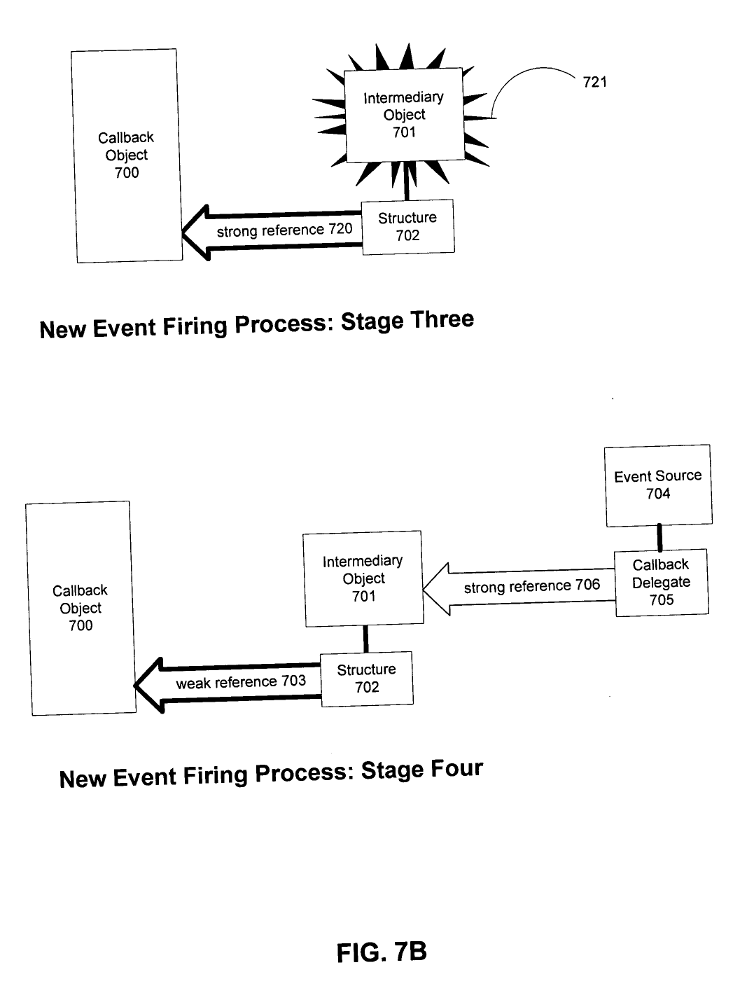

FIG. 7A and FIG. 7B illustrate an embodiment of the Object/Event Communication Model Using Weak References event firing process. In stage one of the event firing process the Callback Object 700 has already subscribed to the event associated with Event Source 704. In this situation the Event Source 704 is linked to the Callback Delegate 705. The Callback Delegate 705 points to the Intermediary Object 701 using Strong Reference 706. Additionally, Structure 702 is linked to the Intermediary Object 701 and is pointing to Callback Object 700 using Weak Reference 703.

In stage two of the event firing process the event associated with Event Source 704 takes place. When this happens the Event Source 704 fires the event (illustrated by 711). The entire set of callback delegates (including Callback Delegate 706) linked to Event Source 704 are executed when the event is fired. The Callback Delegate's 706 method pointer is referencing Intermediary Object 701 using Strong Reference 706. The Intermediary Object 701 now has control of the intercepted event.

In stage three of the event firing process the Intermediary Object 701 locates the Structure 702 that points to Callback Object 700 and determines whether Callback Object 700 has been collected by the garbage collector. If it has, the Intermediary Object 701 just deletes the Structure 702 with Weak Reference 703 and the process is complete. Otherwise, if the Callback Object 700 still exists, the Intermediary Object 701 changes Weak Reference 703 to Strong Reference 720 and fires the event (illustrated by 721) to the Callback Object 700.

Finally, stage four of the event firing process simply completes when the Intermediary Object 701 changes the reference in the Structure 702 pointing to the Callback Object 700 from temporary Strong Reference 720 back to Weak Reference 703.

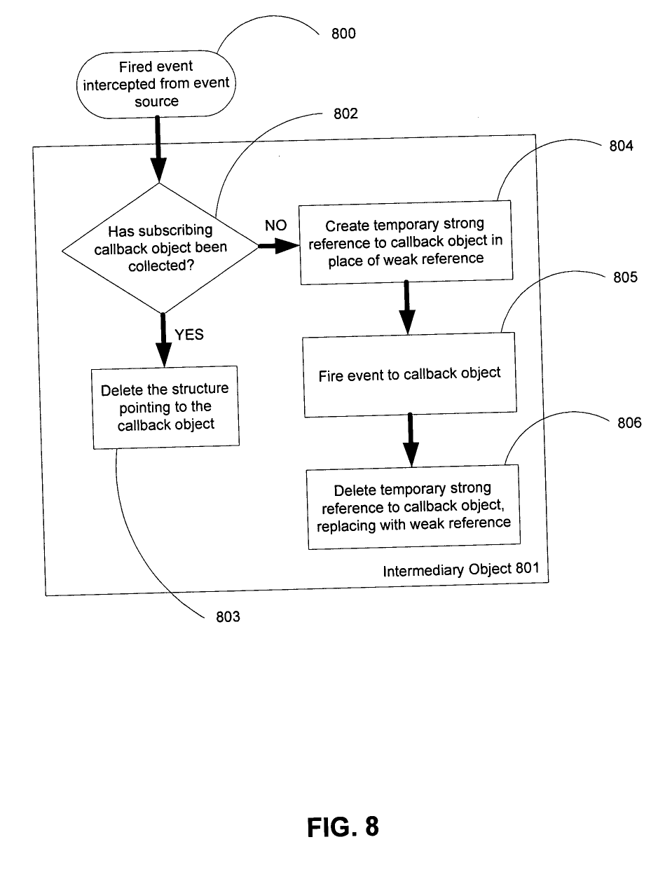

FIG. 8 illustrates a step-by-step process of how fired events are handled in one embodiment of the Object/Event Communication Model Using Weak References. In block 800 a fired event is intercepted from the event source by the Intermediary Object 801. The Intermediary Object 801 then determines if the callback object that subscribed to the event has already been collected by the garbage collector in block 802. If the callback object has been collected then the structure pointing to the callback object is deleted in block 803. If the callback object has not been deleted then the Intermediary Object 801 creates a temporary strong reference to the callback object in place of the current weak reference in block 804. Next, in block 805, the Intermediary Object 801 fires the event to the callback object. Finally, in block 806, the Intermediary Object 801 deletes the temporary strong reference to the callback object and replaces it with the previous weak reference.

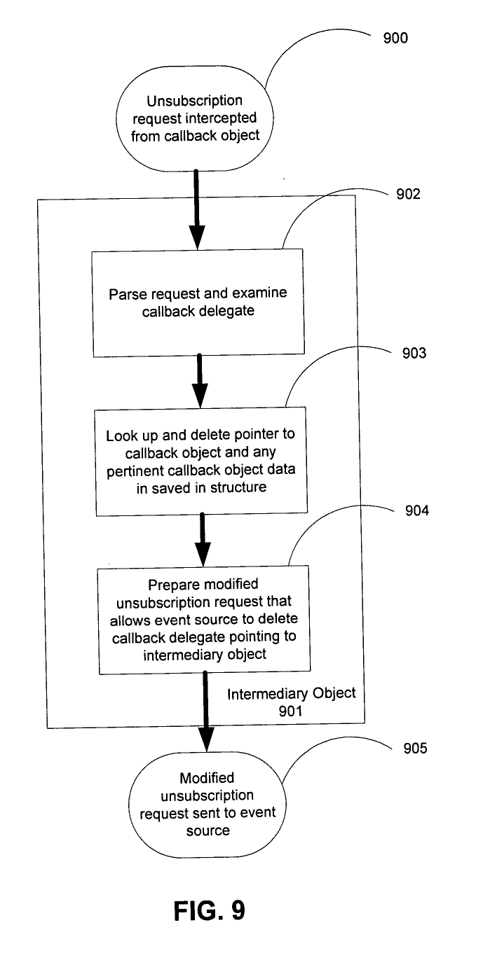

FIG. 9 illustrates a step-by-step process of how event unsubscription requests are handled in one embodiment of the Object/Event Communication Model Using Weak References. In block 900 an unsubscription request is intercepted from the callback object by the Intermediary Object 901. The Intermediary Object 901 then parses the subscription request and examines the callback delegate embedded in the request in block 902. Next, in block 903 the Intermediary Object 901 finds and deletes the structure associated with the callback object. Deleting the structure allows the Intermediary Object 901 to delete any pertinent data related to the callback object and the pointer that references the callback object. At this point all references to the callback object are removed. In block 904 the Intermediary Object 901 then prepares a modified unsubscription request that allows the event source to delete the callback delegate pointing to the Intermediary Object 901. Finally, the Intermediary object sends the modified unsubscription request to the event source in block 905.

Thus, a method for an effective, thread-safe, and transparent way to manage callback objects in an event-based environment is disclosed. Although the Object/Event Communication Model Using Weak References has been described particularly with reference to the figures, it may appear in any number of systems. It is further contemplated that many changes and modifications may be made by one of ordinary skill in the art without departing from the spirit and scope of the disclosed Object/Event Communication Model Using Weak References.

What is claimed is:

1. A method, comprising:
intercepting the communications between a callback object and an event source;
emulating at least a portion of the functionality of the callback object to the event source;
emulating at least a portion of the functionality of the event source to the callback object; and
replacing any strong reference to the callback object with a weak reference.

2. The method according to claim 1, wherein the interception of communications and the emulation functionality are accomplished by utilizing an intermediary object.

3. The method according to claim 2, wherein the intermediary object functions transparently allowing the functionality and continued appearance of direct communication between the callback object and the event source.

4. The method according to claim 1, wherein intercepting the communications between a callback object and an event source further comprises:
allowing the callback object and the event source to conduct ordinary communication operations; and
blocking any in-transit communications between the callback object and the event source to disallow any information to directly pass between the two.

5. The method according to claim 1, wherein the communications between a callback object and an event source further comprises subscription and unsubscription communication requests from the callback object to the event source and event-firing communication broadcasts from the event source to the callback object.

6. The method according to claim 2, wherein the communications between a callback object and an event source further comprises subscription and unsubscription communication requests from the callback object to the event source and event-firing communication broadcasts from the event source to the callback object.

7. The method according to claim 6, wherein the subscription, unsubscription, and event-firing communications between a callback object and an event source are locked at the intermediary object to allow access to only one thread at a time.

8. The method according to claim 1, wherein emulating the functionality of the callback object and the event source further comprises:
receiving and operating on a subscription request from a callback object;
receiving and operating on an unsubscription request from a callback object;
receiving and operating on event-firing requests from an event source when any callback object is subscribed to the event; and
maintaining an exact replica of the API interface of the callback object to the event source.
maintaining an exact replica of the API interface of the event source to the callback object.

9. The method according to claim 8, wherein receiving and operating on a subscription request from a callback object further comprises:
inspecting the callback delegate within the subscription request that the intermediary object received;
creating a structure and storing the information associated with the subscription request, including the reference pointer to the callback object, in the structure;
saving the reference pointer to the callback object as a weak reference in the structure; and
sending a subscription request to the event source that points to the intermediary object.

10. The method according to claim 8, wherein receiving and operating on an unsubscription request from a callback object further comprises:
inspecting the callback delegate within the unsubscription request that the intermediary object received;
deleting the structure that was used to store information associated with the subscription, including the weak reference pointer to the callback object;
sending an unsubscription request to the event source to allow the event source object to delete the callback delegate pointing to the intermediary object.

11. A machine readable medium having embodied thereon instructions, which when executed by a machine, comprises:
intercepting the communications between a callback object and an event source;
emulating at least a portion of the functionality of the callback object to the event source;
emulating at least a portion of the functionality of the event source to the callback object; and
replacing any strong reference to the callback object with a weak reference.

12. The machine readable medium according to claim 11, wherein the interception of communications and the emulation functionality are accomplished by utilizing an intermediary object.

13. The machine readable medium according to claim 12, wherein the intermediary object functions transparently allowing the functionality and continued appearance of direct communication between the callback object and the event source.

14. The machine readable medium according to claim 11, wherein intercepting the communications between a callback object and an event source further comprises:
allowing the callback object and the event source to conduct ordinary communication operations; and
blocking any in-transit communications between the callback object and the event source to disallow any information to directly pass between the two.

15. The machine readable medium according to claim 11, wherein the communications between a callback object and an event source further comprises subscription and unsubscription communication requests from the callback object to the event source and event-firing communication broadcasts from the event source to the callback object.

16. The machine readable medium according to claim 12, wherein the communications between a callback object and an event source further comprises subscription and unsubscription communication requests from the callback object to the event source and event-firing communication broadcasts from the event source to the callback object.

17. A system, comprising:
a bus;
a processor coupled to the bus;
a network interface coupled to the bus; and
memory coupled to the processor, the memory adapted for storing instructions, which upon execution by the processor, cause the interception of communications between a callback object and an event source, at least a portion of the functionality of the callback object is emulated to the event source, at least a portion of the functionality of the event source is emulated to the callback object, and any strong reference to the callback object is replaced with a weak reference.

18. The system according to claim 17, wherein the interception of communications and the emulation functionality are accomplished by utilizing an intermediary object.

19. The system according to claim 18, wherein the intermediary object functions transparently allowing the functionality and continued appearance of direct communication between the callback object and the event source.

20. The system according to claim 17, wherein intercepting the communications between a callback object and an event source further comprises:
allowing the callback object and the event source to conduct ordinary communication operations; and
blocking any in-transit communications between the callback object and the event source to disallow any information to directly pass between the two.

21. The system according to claim 17, wherein the communications between a callback object and an event source further comprises subscription and unsubscription communication requests from the callback object to the event source and event-firing communication broadcasts from the event source to the callback object.

22. The system according to claim 18, wherein the communications between a callback object and an event source further comprises subscription and unsubscription communication requests from the callback object to the event source and event-firing communication broadcasts from the event source to the callback object.
